(19) United States
(12) Patent Application Publication
(10) Pub. No.: US 2008/0239016 A1
(43) Pub. Date: Oct. 2, 2008

(54) LIQUID DISCHARGE HEAD AND LIQUID DISCHARGE APPARATUS

(75) Inventor: Kaoru Miura, Matsudo-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/035,101

(22) Filed: Feb. 21, 2008

(30) Foreign Application Priority Data
Mar. 26, 2007 (JP) 2007-078905

(51) Int. Cl. B41J 2/045

(52) U.S. Cl. 347/68

(57) ABSTRACT

A liquid discharge head is provided, which includes a piezoelectric element for which the polarization characteristic can be recovered without having to apply an electrical field in a direction opposite to that in which an electrical field is to be applied during driving. A piezoelectric element provided for a liquid discharge head of the present invention includes a field-polarization hysteresis characteristic that has, at the least, one hysteresis loop. A saturation polarization point and a critical polarization point, on one hysteresis loop for the hysteresis characteristic, are positioned in the same field polarity, and different signs are provided for a polarization value at the saturation polarization point and for the polarization value at the critical polarization point.

### BACKGROUND OF THE INVENTION

1. Field of the Invention

The present invention relates to a liquid discharge head that includes a piezoelectric device, and a liquid discharge apparatus on which the liquid discharge head is mounted.

2. Description of the Related Art

A liquid discharge head is employed for an image recording apparatus, such as a printer. The liquid discharge head includes: discharge ports, used to discharge a liquid; individual liquid chambers, connected to the discharge ports through orifice communication portions; and discharge means, for discharging liquid held in the individual liquid chambers. The liquid discharge head expands or shrinks the individual liquid chambers to discharge liquid therein through the discharge ports, through the orifice communication portions.

As this type of liquid discharge head, there is a piezo-type liquid discharge head wherein, to discharge a liquid, a voltage is applied to a piezoelectric device, equipped with electrodes, and a vibration plate that forms the wall faces of the individual liquid chambers is displaced. Since this piezo-type liquid discharge head does not require heat for the discharge process, one advantage of this type of head is that there are few restrictions imposed on the kind of liquid that can be discharged.

It is generally known that when a piezoelectric device has been driven for a long time, a frequently noted phenomenon is deterioration of the displacement function. In many cases, a ferroelectric material is employed as a piezoelectric material, and another well-known fact, in this case, is that deterioration of the displacement function is caused by the degrading of the polarization characteristic of the ferroelectric element.

The degrading of the remnant polarization of the polarization characteristic of a ferroelectric element (a phenomenon wherein the absolute value of the remnant polarization becomes smaller in accordance with a time-transient change) is generally called “polarization fatigue”, or simply called “fatigue”. A clearly defined origin for fatigue has not as yet been found; however, from many experimental results obtained for ferroelectric oxide material, it is obvious that there is a specific relationship between fatigue and oxygen deficiency.

It is generally believed that oxygen deficiency results from a positive charge. Therefore, oxygen deficiency can be moved within a ferroelectric material by applying a voltage. There is a model proposed wherein fatigue appears because, through the application of a voltage, oxygen deficiency is concentrated near the interface of an electrode and it is possible to explain many experimental results.

Furthermore, there is another report that explains the origin of fatigue as being the deterioration of a polarization characteristic by an internal electric field that is generated in a ferroelectric element (see Japanese Patent Application Laid-Open No. 2006-068970).

While taking these facts into account, it can easily be assumed that it should be understood that an internal electric field is rendered rigid by a specific action of oxygen deficiency that is concentrated near an electrode interface, through application of a voltage, and as a result, fatigue occurs.

As a countermeasure for repressing the deterioration of the displacement function of a piezoelectric device made of a ferroelectric material, a method is proposed that is characterized in that, as shown in FIG. 11, an electrical field, equal to or higher than a coercive electric field, is applied in a direction opposite that of an electric field applied during driving (see Japanese Patent Application Laid-Open No. 2006-068970). It can easily be conjectured that this method will be an effective one for dispersing an oxygen deficiency concentrated in the vicinity of the electrode interface, and for resetting an internal electrical field that has been rendered rigid.

However, according to the method whereby the polarization characteristic is recovered by applying an electrical field equal to or higher than a coercive electrical field in the direction opposite to that at the driving time, a problem that the cost will be increased because a circuit provided for driving will become complicated. That is, a power source device that can supply both positive and negative power voltages must be prepared. Further, since an electrical field equal to or higher than a coercive electrical field is applied in the direction opposite to that at the driving time, there is another problem in that a load imposed on a piezoelectric device will be increased.

There is a method for employing an anti-ferroelectric material for a piezoelectric device in order to improve the piezoelectric effect, not to recover the polarization characteristic (see Japanese Patent Application Laid-Open No. H10-052071). When an anti-ferroelectric material is employed for a piezoelectric device, an electrical field need only be set to zero, so that half of the total polarization can be reversed, without requiring an application in the direction opposite that at the driving time.

However, even in a case wherein an electrical field applied to the anti-ferroelectric material is zero, it is assumed that not too great an effect should be expected for the recovery of the polarization characteristic. This is because, in a case wherein an electrical field of zero is applied, almost no effect will be obtained when a positively charged oxygen deficiency is to be dispersed inside a crystal.

While taking the above described problems of the prior art into account, the following is a desirable piezoelectric device in order to regress the deterioration of the displacement function of a piezoelectric device made of a ferroelectric material or an anti-ferroelectric material, i.e., a piezoelectric device such that, without an electrical field being applied in the opposite direction at the time of driving, an oxygen deficiency inside a crystal can be dispersed and the polarization characteristic can be recovered.

A method is herewith proposed, whereby a ferroelectric material having a hysteresis characteristic, as shown in FIG. 12, is employed for a piezoelectric device for the purpose of using the piezoelectric device in a large electrical field area, not for the purpose of depressing deterioration of a displacement function (see Japanese Patent Application Laid-Open No. 2003-243741). By employing this method, polarization reversal can be performed without having to apply an electrical field in a direction opposite to an electrical field to be applied at the time of driving, and an oxygen deficiency can be dispersed inside a crystal so as to recover the polarization characteristic. A description, given in “Relation Between Lattice Misfit Strain and Ferroelectric Properties”, Kazuhide Abe, Surface Technology, vol. 51, No. 7, 2000, pp. 684-688, that “when a lattice misalignment is present between a substrate and an overlaid ferroelectric material the hysteresis characteristic becomes laterally asymmetrical at a polarization axis”, is cited in paragraph

of Japanese Patent Application Laid-Open No. 2003-243741. And in Japanese Patent Application Laid-Open No. 2003-243741, a description is given that the hysteresis characteristic, which is shown in FIG. 12 and which is asymmetrical at the polarization axis, can be provided by employing a technique described in “Lattice Strain By Stress And Ferroelectric Materialization Mechanism”, Kazuhide Abe, Surface Technology, 2000, vol. 51, No. 7, p. 684-688.

However, it is very difficult to actually provide a ferroelectric material having a hysteresis characteristic, as shown in FIG. 12. This is because a direction for applying an electrical field and a direction for polarizing a ferroelectric element are closely related to each other, and in order to perform polarization reversal, it is always required that the application of an electrical field be performed in the direction opposite that used to polarize a ferroelectric element. In this connection, not especially mentioned in “Lattice Strain By Stress And Ferroelectric Materialization Mechanism”, Kazuhide Abe, Surface Technology, 2000, vol. 51, No. 7, p. 684-688, quoted in Japanese Patent Application Laid-Open No. H10-052071, is a lattice misalignment and a bilateral asymmetry of a hysteresis characteristic along the polarization axis, and as a basis for this, it is not explained that the source of the bilateral asymmetry of the hysteresis characteristic is a lattice misalignment. Naturally, the probability that the same sign will be provided for coercive electrical fields Ec1 and Ec2 is not mentioned at all. Therefore, it can be ascertained that it is very difficult for the hysteresis characteristic shown in FIG. 12 to be provided using a ferroelectric material.

### SUMMARY OF THE INVENTION

One objective of the present invention is to provide a liquid discharge head comprising a piezoelectric element, the polarization characteristic of which can be recovered without having to apply an electrical field in the opposite direction when applying an electrical field during driving, and a liquid discharge apparatus.

In order to achieve the above described objective, a liquid discharge head of the present invention, comprising a liquid chamber communicated with a discharge port for discharging a liquid and a piezoelectric element provided in consonance with the liquid chamber, is characterized in that: the piezoelectric element has a field-polarization hysteresis characteristic that includes at least one hysteresis loop, and a saturation polarization point and a critical polarization point on the hysteresis loop are positioned in the same field polarity; and a sign differs between a polarization value at the saturation polarization point and a polarization value at the critical polarization point.

According to the present invention, a liquid discharge head that includes a piezoelectric element, the polarization characteristic of which can be recovered without having to apply an electrical field in the opposite direction when an electrical field is applied during driving, and a liquid discharge apparatus.

Further features of the present invention will become apparent from the following description of exemplary embodiments with reference to the attached drawings.

### BRIEF DESCRIPTION OF THE DRAWINGS

FIG. 1 is a diagram illustrating a polarization-field hysteresis characteristic for a piezoelectric element according to a first embodiment of the present invention.

FIG. 2 is a diagram illustrating a polarization-field hysteresis characteristic for an anti-ferroelectric member.

FIGS. 3A and 3B are schematic cross-sectional views of the polarization of the anti-ferroelectric member depicting a hysteresis characteristic shown in FIG. 2.

FIGS. 4A and 4B are diagrams illustrating a schematic structure in which a ferroelectric element is laminated on an anti-ferroelectric member.

FIG. 5 is a diagram illustrating polarization-field hysteresis characteristics for the anti-ferroelectric member and the ferroelectric element, respectively.

FIG. 6 is a diagram illustrating a drive pulse according to the first embodiment of the present invention.

FIG. 7 is a cross-sectional view of the structure of a liquid discharge head according to the first embodiment of the present invention.

FIGS. 8A, 8B, 8C, 8D and 8E are diagrams illustrating steps for the production of the liquid discharge head shown in FIG. 7.

FIG. 9 is a diagram illustrating a polarization-field hysteresis characteristic for an anti-ferroelectric member according to a second embodiment of the present invention.

FIG. 10 is a perspective view illustrating a liquid discharge apparatus for which the present invention can be applied.

FIG. 11 is a diagram for explaining application of an electrical field according to prior art.

FIG. 12 is a diagram illustrating a hysteresis characteristic for a piezoelectric element according to prior art.

### DESCRIPTION OF THE EMBODIMENTS

Preferred embodiments of the present invention will now be described in detail in accordance with the accompanying drawings.

### First Embodiment

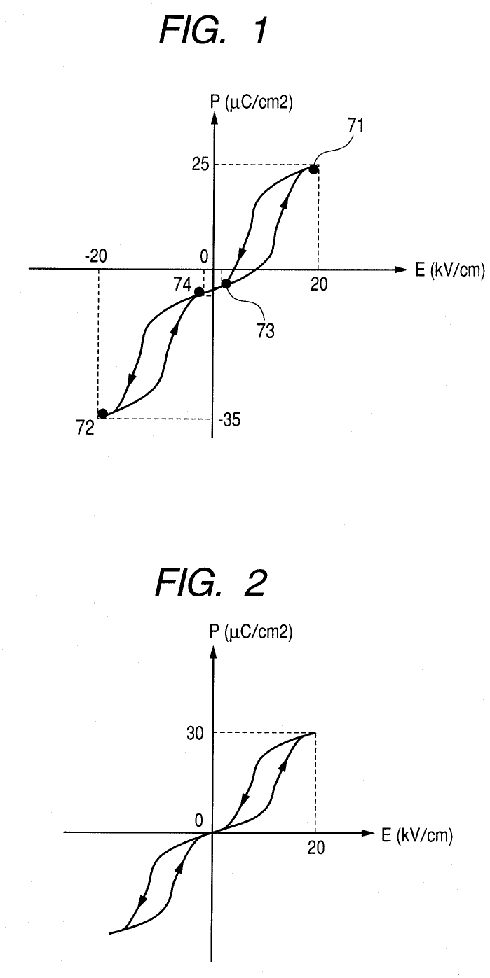

A first embodiment of the present invention will be described while referring to FIGS. 1 to 8.

FIG. 1 is a diagram illustrating a polarization-field hysteresis characteristic of a piezoelectric element according to this embodiment. The piezoelectric element of this embodiment is formed of a piezoelectric material including an anti-ferroelectric member. A method for obtaining the hysteresis characteristic shown in FIG. 1 will now be described.

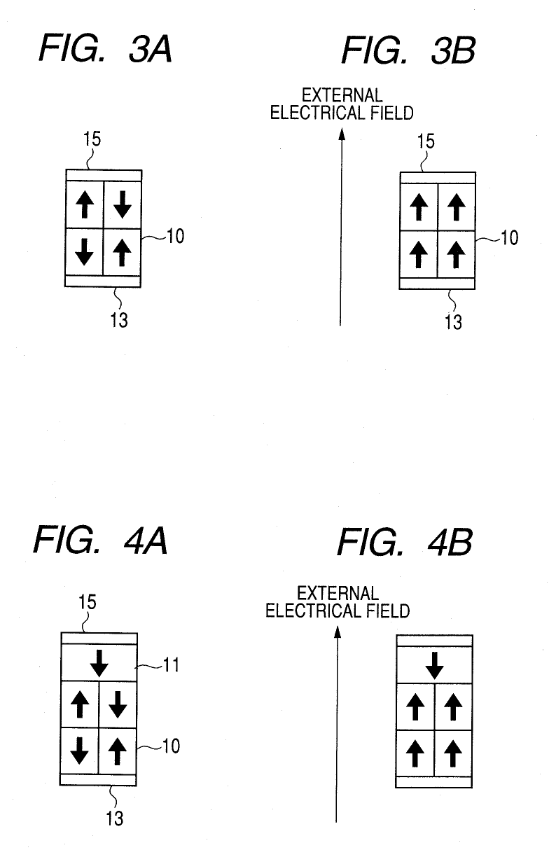

FIG. 2 is a diagram illustrating a polarization-field hysteresis characteristic for an anti-ferroelectric member, and FIGS. 3A and 3B are schematic cross-sectional views of the polarization of the anti-ferroelectric member that exhibits the hysteresis characteristic shown in FIG. 2. As shown in FIG. 3A, when an external electrical field is not present, polarization of the anti-ferroelectric member indicates an opposite direction for each unit lattice (unit cell) of a crystal, and a polarization value for the entire anti-ferroelectric member is zero. On the other hand, in a case wherein, as shown in FIG. 3B, a voltage is applied, for example, to an upper electrode 15 and a lower electrode 13, and thus an external electrical field is generated for the anti-ferroelectric member 10, all the polarizations occur in the same direction, consonant with the external electrical field, and the characteristic is changed from the anti-ferroelectric state to the ferroelectric state. Further, when the external electrical field is in the opposite direction, polarizations are also aligned in the opposite direction. Based on this reason, the anti-ferroelectric member exhibits a hysteresis characteristic having two hysteresis loops, as shown in FIG. 2.

Lead zirconate stannate (PbZr_{0.6}Sn_{0.4}O₃: PZS), for example, is employed as the material of the anti-ferroelectric member 10. A PZS solution is applied, using spin coating, to the lower electrode 13 made of platinum (Pt), for example, and after the PZS solution is dried, it is crystallized by performing a thermal process at 700° C. for one hour, and as a result, a PZS film holding the hysteresis characteristic in FIG. 2 is obtained. In addition, when the upper electrode 15 is deposited using platinum (Pt), the structure shown in FIG. 3 can be provided.

The schematic structure wherein a ferroelectric element is laminated on an anti-ferroelectric member is illustrated in FIGS. 4A and 4B. The anti-ferroelectric member 10 and a ferroelectric element 11 are laminated between the upper electrode 15 and the lower electrode 13. It should be noted that in this embodiment the ferroelectric element 11 is formed of a material such that the coercive electrical field of the ferroelectric element 11 has a greater value than an electrical field that reaches the saturation polarization point of the anti-ferroelectric member 10. For this embodiment, lead lanthanum zirconate titanate (Pb_{0.95}La_{0.05}Zr_{0.2}Ti_{0.8}O₃; PLZT), which is doped with lanthanum (La), is employed. A PLZT solution is applied, using spin coating, to the PZS anti-ferroelectric member 10, which is deposited, using the same method described above, and after the PLZT solution is dried, it is crystallized by performing a thermal process at 700° C. for one hour, so that a PLZT thin film is obtained.

As shown in FIG. 4A, when the external electrical field is not present, polarization of the anti-ferroelectric member 10 occurs in opposite directions for each unit lattice (unit cell) of a crystal, and the polarization value of the entire anti-ferroelectric member 10 is zero. On the other hand, polarization of the ferroelectric element 11 occurs in only one direction, even when the external electrical field is not present. At this time, an external electrical field is applied that has a value that is greater than an electrical field that reaches a saturation polarization point for the anti-ferroelectric member 10 and that is smaller than the coercive electrical field of the ferroelectric element 11. The polarization state at this time is as shown in FIG. 4B, and all the polarizations performed for the anti-ferroelectric member 10 are aligned in the same direction, consonant with the external electrical field, and the characteristic is changed from the anti-ferroelectric state to the ferroelectric state. On the other hand, polarization reversal does not occur for the ferroelectric element 11 because the value of the external electrical field is smaller than the value of the coercive electrical field. It should be noted that, in this embodiment shown in FIGS. 4A and 4B, the direction from the lower electrode 13 to the upper electrode 15 is defined as the direction of the positive electrical field.

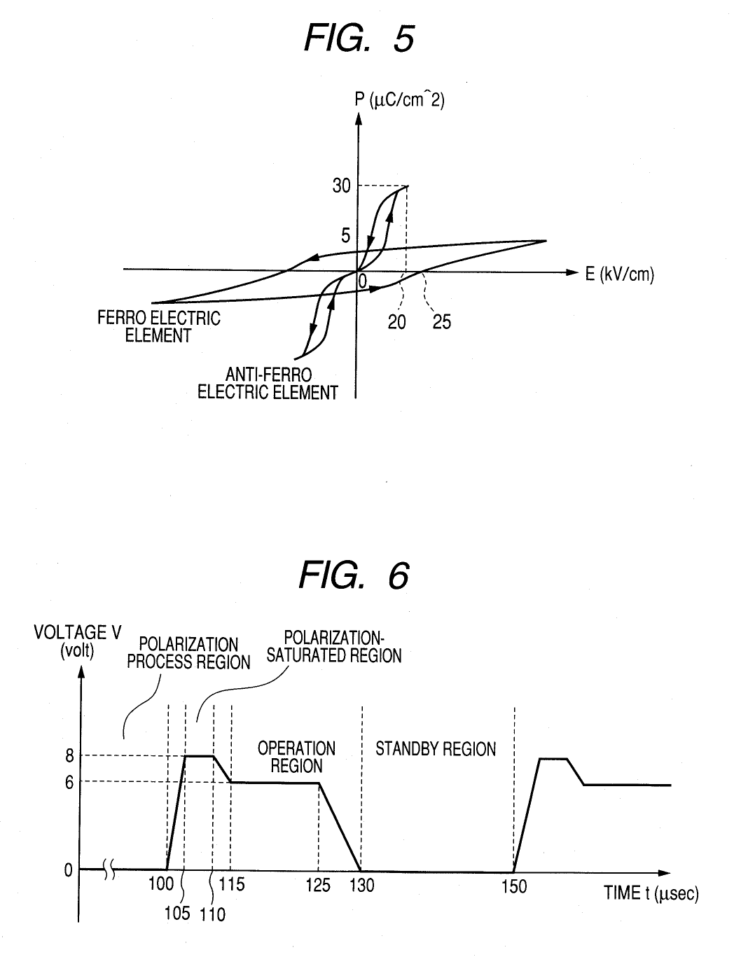

The polarization-field hysteresis characteristics for the respective anti-ferroelectric member 10 and the ferroelectric element 11 are shown in FIG. 5. The composition of these two hysteresis characteristics is the polarization-field hysteresis characteristic shown in FIG. 1 for this embodiment. According to the polarization-field hysteresis characteristic shown in FIG. 1, the saturation polarization point and the critical polarization point on one hysteresis loop of the hysteresis characteristic are located in the same field polarity. Specifically, a saturation polarization point 71 and a critical polarization point 73 are located in the same field polarity, while a saturation polarization point 72 and a critical polarization point 74 are located in the same field polarity. Here, when the saturation polarization point 71 and the critical polarization point 73 are located in the same field polarity, it is assumed that this also indicates that the critical polarization point 73 is located at the position zero.

Here, a “saturation polarization point” is defined as a state established when the individual polarizations of either the ferroelectric element or the anti-ferroelectric member are all aligned in the same direction by the external electrical field, etc. For example, according to the polarization-field hysteresis characteristic in FIG. 1, points denoted by numerals 71 and 72 are saturation polarization points. Furthermore, a “critical polarization point” is defined as a critical point at which one hysteresis loop starts to appear when the absolute value of an external electrical field is gradually increased from zero. For example, according to the polarization-field hysteresis characteristic in FIG. 1, points denoted by numerals 73 and 74 are critical polarization points.

As previously described, according to this embodiment a ferroelectric material such that the coercive electrical field of the ferroelectric element 11 has a greater value than has an electrical field that has reached a saturation polarization point for the anti-ferroelectric member 10 is employed for the anti-ferroelectric member 10 and the ferroelectric element 11. Therefore, polarization reversal of the ferroelectric element 11 does not occur in the polarization operation region of the anti-ferroelectric member 10. As a result, as shown in FIG. 1, for example, the hysteresis characteristic of this embodiment is substantially the same as the hysteresis characteristic of the anti-ferroelectric member that is shifted in the negative polarization direction, and polarization values having different signs are provided for the saturation polarization point and the critical polarization point.

It is preferable that, as shown in FIG. 4, a structure wherein the ferroelectric element 11 be deposited after the anti-ferroelectric member 10 has been formed. This is because it is assumed that an oxygen deficiency is charged positively, and is concentrated more in the vicinity of the interface of the upper electrode 15. A three-layer structure may also be employed, wherein after the anti-ferroelectric member 10 is formed, the ferroelectric element 11 is deposited and another anti-ferroelectric member 10 is overlaid.

The method for obtaining the hysteresis characteristic shown in FIG. 1 has been described.

When an anti-ferroelectric member exhibiting the hysteresis characteristic shown in FIG. 1 is employed for a liquid discharge head, the polarization characteristic can be recovered without having to invert an electrical field to be applied. This is because the ferroelectric element 11 is polarized in the direction opposite to the external electrical field, and using an electrical field generated by polarization, an oxygen deficiency can be dispersed, moved from the vicinity of the electrode interface to inside the dielectric element. Since the oxygen deficiency has been dispersed, the internal electrical field is relaxed and is no longer rendered rigid.

Further, the hysteresis characteristic in FIG. 1 may be shifted in the positive field direction. The electrical field consonant with and equivalent to the shift is generally known as a built-in field. This built-in field is a phenomenon that appears in a case wherein, for example, electrode materials having different work functions are employed for the lower electrode 13 and the upper electrode 15.

FIG. 6 is a diagram illustrating an example drive pulse for this embodiment.

As shown in FIGS. 4A, 4B and 5, when the external electrical field (a voltage according to a drive pulse) is zero, polarization of the anti-ferroelectric member 10 indicates zero, representing the state wherein the internal electrical field has disappeared and the polarization characteristic has been recovered. That is, the standby state wherein the electrical field is zero and the polarization process has also been performed is obtained. On the other hand, since PLZT, used to form the ferroelectric element 11, is known to be a material that resists fatigue, the polarization reversal process is not required. The polarization process is not necessarily performed each time, and need only be performed at a set frequency, such as once every time a printer is powered on. When a liquid discharge head is to be operated the next time, first, an electrical field (a corresponding voltage according to a drive pulse) is applied at a greater level than that whereat saturation polarization point is reached for the anti-ferroelectric member 10. Thereafter, an electrical field (a corresponding voltage according to a drive pulse) consonant with a discharge operation is applied, and thus, the discharge operation is enabled by using an electrical field that has only one polarity (a voltage according to a drive pulse). The process for a polarization-saturated region should be performed in each instance in order to provide the same polarization direction.

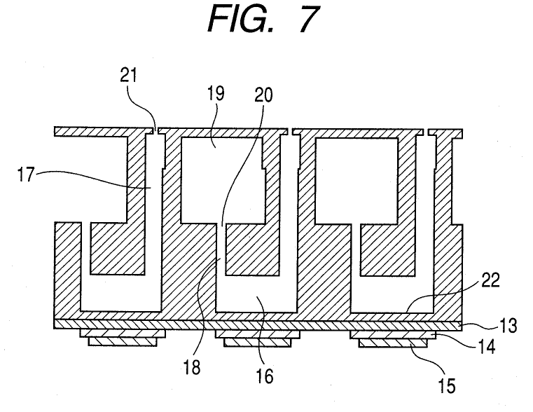

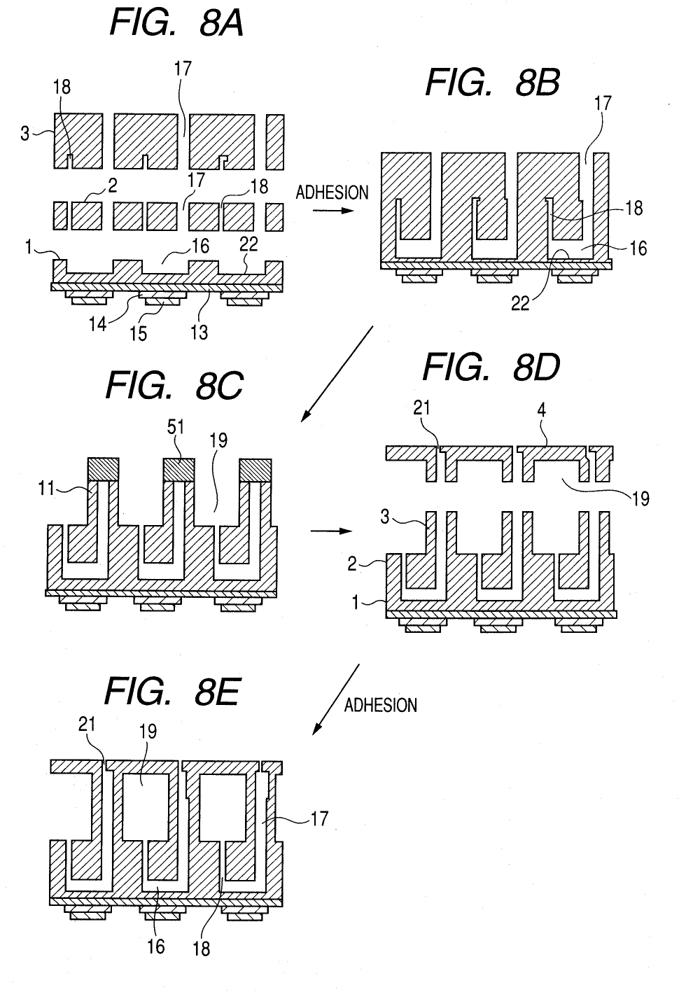

FIG. 7 is a cross-sectional view illustrating the structure of a liquid discharge head according to this embodiment. This liquid discharge head is obtained by performing the manufacturing steps shown in FIGS. 8A to 8E. A manufacturing method for the entire liquid discharge head of this embodiment will now be described while referring to FIGS. 8A to 8E.

First, as shown in FIG. 8A, three types of substrates 1, 2 and 3 that are to be patterned are prepared. Si substrates, SOI (Silicon-On-Insulator) substrates, etc., can be employed as the individual substrates 1, 2 and 3, and while taking the following pattering step into account, SOI substrates can appropriately be employed. For example, an SOI substrate, for which the silicon (Si) thickness is 199.5 μm, the oxide silicon (SiO₂) thickness is 0.5 μm and the total thickness is 200 μm, is employed as the first substrate 1 and the second substrate 2, while an SOI substrate, for which the silicon (Si) thickness is 399.5 μm, the oxide silicon (SiO₂) thickness is 0.5 μm and the total thickness is 400 μm, is employed as the third substrate 3.

Sequentially, the patterning for the first substrate 1 and the formation of an electrode, a piezoelectric film and a vibration plate on the first substrate 1 are performed. Individual liquid chambers 16 are to be patterned in the first substrate 1. The bottom face for the individual liquid chambers 16 is formed as a vibration plate 22 composed of silicon (Si), and its thickness is set, for example, at 6 μm. Then, the lower electrode 13, composed of platinum (Pt) and having a film thickness of 0.3 μm, a piezoelectric film 14, having a film thickness of 3.0 μm, and the upper electrode 15, composed of platinum (Pt) and having a film thickness of 0.3 μm, are deposited. These and the vibration plate 22 constitute means for expanding or shrinking the individual liquid chambers 16. For film deposition for the lower electrode 13 and the upper electrode 14, a well known film deposition method, such as sputtering, laser ablation or MOCVD, is employed. Further, for the piezoelectric film 14, a structure is employed such as that shown in FIG. 4, wherein a ferroelectric element 11 having a film thickness of 0.5 μm is laminated on an anti-ferroelectric member 10 having a film thickness of 2.5 μm.

Furthermore, orifice communication portions 17, having a diameter of 60 μm, and common liquid chamber communication portions 18, having a diameter of 10 μm, are patterned in the second and third substrates 2 and 3.

Patterning for the substrates 1, 2 and 3 is performed, for example, using chemical etching or ion milling. After the patterning has been completed, the individual substrates are flattened.

Following this, as shown in FIG. 8B, the first, second and third substrates 1, 2 and 3 are adhered to each other. For the adhesion of these substrates, a gold (Au)-gold (Au) bonding technique is employed. As a result, the orifice communication portions 17 and the common liquid chamber communication portions 18, which are formed in the individual second and third substrates 2 and 3, are connected together.

Next, as shown in FIG. 8C, a common liquid chamber 19 is to be patterned. Patterning of the common liquid chamber 19 is performed for the areas of the substrates that have been adhered in the above manner, other than those areas where the orifice communication portions 17 are formed. As a result, orifice communication columnar portions 11 that form the orifice communication portions 17 are provided. For this patterning, chemical etching or ion milling, for example, is employed. A patterning process performed using chemical etching is shown in FIG. 8C, wherein the state indicated is that immediately after a resist 51 has been applied to the third substrate 3, which serves as the topmost layer of the three substrates when adhered together, and chemical etching is performed. The resist 51 is removed thereafter.

Sequentially, as shown in FIG. 8D, a fourth substrate 4 to be patterned is prepared. An Si substrate, an SOI substrate, etc., can also be employed as the fourth substrate 4, and while taking the following patterning into account, an SOI substrate can appropriately be employed. For example, an SOI substrate, for which the silicon (Si) thickness is 199.5 μm, the oxide silicon (SiO₂) thickness is 0.5 μm and the total thickness is 200 μm, can be employed as the fourth substrate 4.

The orifice communication portions 17, the common liquid chamber 19 and discharge ports 21 are to be patterned in the fourth substrate 4. The size of a discharge port 21 is, for example, 30 μm in diameter and 50 μm in height. The patterning is performed, for example, using chemical etching or ion milling. After the patterning has been completed, the fourth substrate 4 is flattened.

Finally, as shown in FIG. 8E, the fourth substrate 4 is adhered to the third substrate 3. For the adhesion, the gold (Au)-gold (Au) bonding technique, for example, is employed.

Through this processing, the first to fourth substrates are assembled, and a liquid discharge head is obtained that includes: the common liquid chamber 19; the common liquid chamber communication portions 18, which communicate with the common liquid chamber 19 and the individual liquid chambers 16; and the orifice communication portions 17, arranged so that one end of each communicates with an individual liquid chamber 16 and the other end communicates with a discharge port 21.

### Second Embodiment

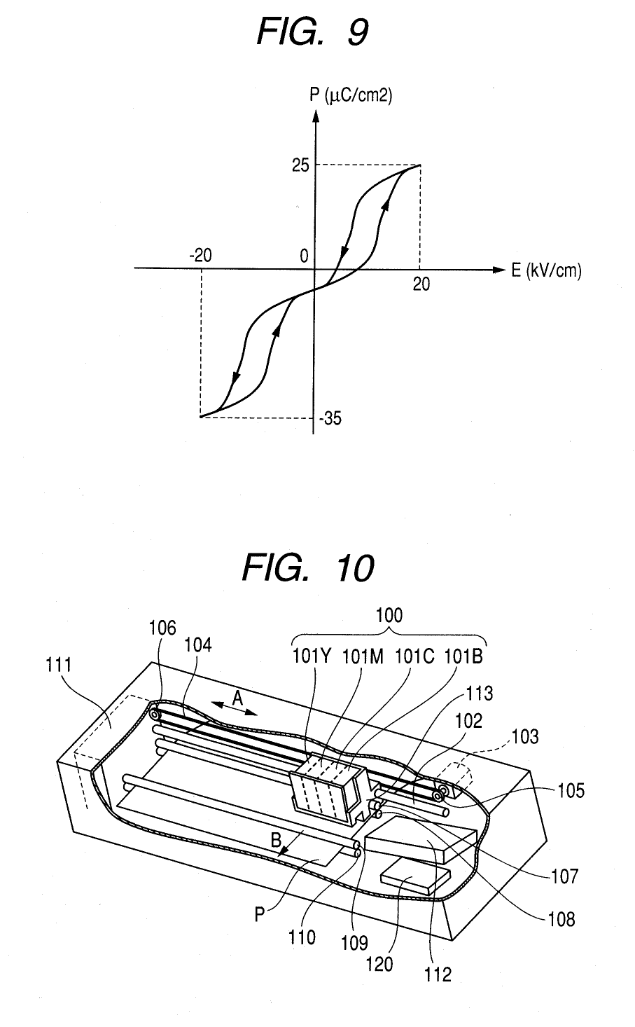

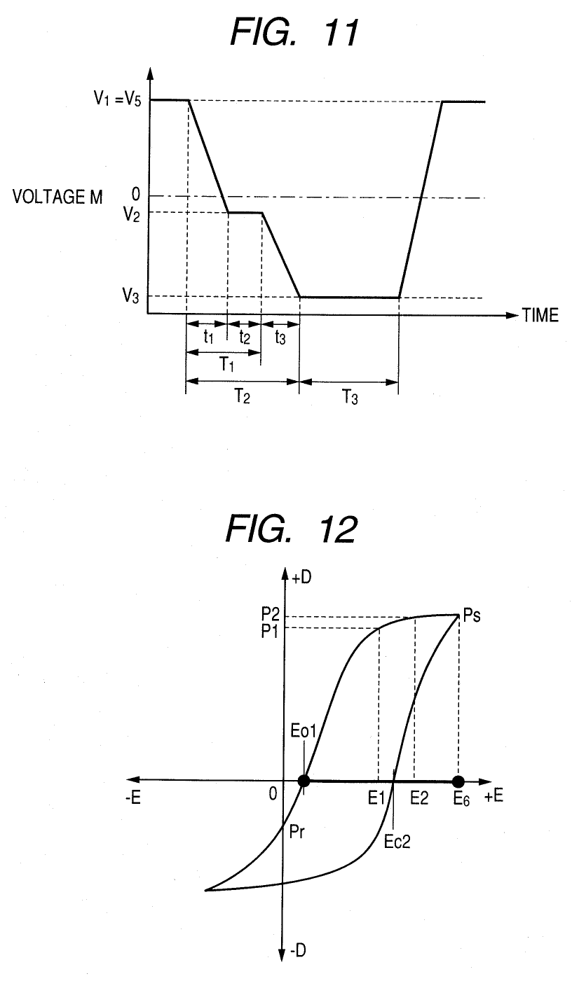

A second embodiment of the present invention will now be described while referring to FIG. 9. A polarization-field hysteresis characteristic for an anti-ferroelectric member according to this embodiment is shown in FIG. 9.

The structure and the manufacturing method for an anti-ferroelectric member and a liquid discharge head for this embodiment are substantially the same as those for the first embodiment. Therefore, the same reference numerals as are used for the first embodiment are provided for the individual components that are described for this embodiment.

The structure and the manufacturing method of the anti-ferroelectric member according to this embodiment will be described while referring to FIG. 3. An anti-ferroelectric member 10 in this embodiment internally has a space-charge polarization. In this embodiment, PZS, for which aging has been performed, for example, is employed as the material used for the anti-ferroelectric member 10. A PZS solution is applied, using spin coating, to a lower electrode 13 made of platinum (Pt), for example, and after the solution has dried, it is crystallized by performing a thermal process at 700° C. for one hour, following which an upper electrode 15 is deposited using platinum (Pt), for example. Thereafter, an external electrical field (e.g., 30 kV/cm), equal to or higher than an electrical field at a saturation polarization point, is applied to polarize the structure in a ferroelectric phase, and aging is performed in a state wherein an external electrical field is applied on condition of, for example, 50° C. for two hours. Through the aging, a space-charge polarization has appeared inside the anti-ferroelectric member 10 and a PZS film is obtained, which represents a hysteresis characteristic that is asymmetrical with the field axis, as shown in FIG. 9.

In addition, as well as in the first embodiment, the hysteresis characteristic in FIG. 9 may be shifted in the positive field direction. An electrical field consonant with such a shift is generally known as a built-in electrical field. A built-in electrical field is a phenomenon that appears in a case wherein, as in the first embodiment, for example, electrode materials having different work functions are employed for the lower electrode and the upper electrode.

It should be noted that, as well as in the first embodiment, the drive pulse shown in FIG. 6, for example, is employed for the anti-ferroelectric member 10 of this embodiment.

### Third Embodiment

A liquid discharge apparatus according to a third embodiment of the present invention will now be described while referring to FIG. 10. FIG. 10 is a perspective view illustrating a liquid discharge apparatus for which the present invention can be applied.

The liquid discharge apparatus of this embodiment includes feeding rollers 109 and 110 for conveying a recording medium P. A recording medium P. when inserted into the liquid discharge apparatus, is conveyed by the feeding rollers 109 and 110 to a recording enabled area for a liquid discharge head unit 100.

The liquid discharge head unit 100 is guided, by two guide shafts 107 and 102, so as to be movable in a direction in which the guide shafts are extended (main scanning direction), and reciprocally scans the recording area. In this embodiment, the direction in which the liquid discharge head 100 scans is regarded as the main scanning direction, and the direction in which the recording medium P is conveyed is regarded as the sub-scanning direction. A liquid discharge head 113, the cross section of which is shown in FIG. 7, and ink tanks 101 for supplying ink to the common liquid chamber 19 (see FIG. 7, etc.) are mounted on the liquid discharge head unit 100. Four ink tanks, i.e., an ink tank 101B for black ink, an ink tank 101C for cyan ink, an ink tank 101M for magenta ink and an ink tank 101Y for yellow ink, for example, are mounted on the liquid discharge head unit 100. The ink tanks for the individual colors are designed to be independently exchangeable, relative to the liquid discharge head unit 100. Four liquid discharge heads 113 are mounted on the liquid discharge head unit (the mounting member) 100. The liquid discharge heads 113 are respectively connected to the color ink tanks, and inks in the individual colors are supplied to the common liquid chambers 19 of the liquid discharge heads 113.

Further, a recovery system unit 112 is arranged below the right edge, in the drawing, of the movable area of the liquid discharge head unit 100. The recovery system unit 112 performs a recovery process for the liquid discharge port sections of the liquid discharge heads 113 when the recording operation is not being performed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-078905, filed Mar. 26, 2007, which is hereby incorporated by reference herein in its entirety.

What is claimed is:

1. A liquid discharge head comprising a liquid chamber communicated with a discharge port for discharging a liquid and a piezoelectric element provided corresponding to the liquid chamber, characterized in that:
the piezoelectric element has a field-polarization hysteresis characteristic that includes at least one hysteresis loop, and a saturation polarization point and a critical polarization point on the hysteresis loop are positioned in the same field polarity; and
a sign differs between a polarization value at the saturation polarization point and a polarization value at the critical polarization point.

2. A liquid discharge head according to claim 1, wherein the piezoelectric element includes an anti-ferroelectric member and a ferroelectric member; and wherein the ferroelectric member is made of a material such that a coercive electrical field of the ferroelectric member has a greater value than an electrical field that reaches a saturation polarization point for the anti-ferroelectric member.

3. A liquid discharge head according to claim 1, wherein the piezoelectric element includes an anti-ferroelectric member that internally has a space-charge polarization.

4. A liquid discharge head according to claim 2, wherein the piezoelectric element includes an anti-ferroelectric member that internally has a space-charge polarization.

5. A liquid discharge apparatus comprising:
a liquid discharge head according to claim 1; and
a mounting member, on which the liquid discharge head is to be mounted.
